(19) United States
(12) Patent Application Publication
(10) Pub. No.: US 2024/0062050 A1
(43) Pub. Date: Feb. 22, 2024

(54) Auxiliary Visualization Network

(71) Applicant: AUTOBRAINS TECHNOLOGIES LTD, Tel Aviv-Yafo (IL)

(72) Inventors: Julius Engelsoy, Tel-Aviv (IL); Armin Biess, Tel-Aviv (IL); Isaac Misri, Tel-Aviv (IL); Joey Hendry, Bat-Yam (IL)

(73) Assignee: AUTOBRAINS TECHNOLOGIES LTD, Tel Aviv-Yafo (IL)

(21) Appl. No.: 18/497,969

(22) Filed: Oct. 30, 2023

Related U.S. Application Data
(63) Continuation-in-part of application No. 18/355,324, filed on Jul. 19, 2023.
Application No. 18/355,324 is a continuation-in-part of application No. 17/823,069, filed on Aug. 29, 2022.
(60) Provisional application No. 63/260,839, filed on Sep. 1, 2021.
(60) Provisional application No. 63/373,454, filed on Aug. 24, 2022.
(60) Provisional application No. 63/368,874, filed on Jul. 19, 2022.

(51) Int. Cl. G06N 3/0475; G06T 11/00

(52) U.S. Cl. CPC G06N 3/0475; G06T 11/00

(57) ABSTRACT

A method for explainable representation, the method includes: (a) receiving, by an auxiliary representation network, information regarding an environment of a vehicle; the information being destined to be processed by a policy model, to provide driving related decisions at a current point of time; and (b) generating, by the auxiliary representation network, an interpretable representation of predicted outcomes of the policy model during a period of time that ends after the current point of time.

### CROSS REFERENCE

This application is a continuation in part of U.S. patent application Ser. No. 18/355,324 filing date Jul. 19, 2023 which is a continuation in part of U.S. patent application Ser. No. 17/823,069 filing date Aug. 29, 2022, that claims priority from U.S. provisional application 63/260,839 which is incorporated herein by reference.

### BACKGROUND

Advanced Driver Assistance System (ADAS) operations and autonomous vehicle driving operations may alarm a human driver and may cause the human driver to perform errors that may damage himself and the vehicle.

There is a growing need to provide more information about the expected behavior of the vehicle.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a vehicle;

FIG. 3 illustrates an example of an image;

FIG. 4 illustrates an example of an image; and

FIG. 5 illustrates an example of a method.

### DESCRIPTION OF EXAMPLE EMBODIMENTS

According to an embodiment, driving related decisions of a vehicle are generated by using a policy model. The policy model applies one or more policies on information such as an information related to an environment of the vehicle and on additional information such as information related to the vehicle itself (also referred to as an ego vehicle). According to an embodiment, the additional information is kinematic information related to the vehicle (such as speed, acceleration), information related to the operation of vehicle components (such as dumping operations, state of the chassis, gas pedal location, driving wheel rotations), and the like.

According to an embodiment, the policy model is at least one of:
A virtual field related policy.
A policy that is not a virtual field related policy.
A policy that is only based in part on a virtual field related policy.
A policy that applies safety considerations.
A policy that applies considerations regarding traffic laws and/or regulations.
A policy that applies environmental conditions.
A policy that applies driver and/or passenger convenience considerations.
A policy that applies one or more vehicle constraints.
A policy that is an artificial intelligence (AI) based policy.
A policy that is a rule based policy.
A policy that differs from an AI based policy.
A policy that outputs autonomous driving related decisions.
A policy that outputs advance driving assistance system (ADAS) driving related decisions.

It has been found that providing a prediction, to a driver regarding the future outcomes of the policy model is highly beneficial.

According to an embodiment, the prediction assists the driver (when the driver controls the progress of the vehicle) to follow a preferred path and/or reduces the amount of abrupt changes in the control of the vehicle—thereby reducing communication and processing resources required to implement the drivers control.

According to an embodiment, the prediction increases the comfort level of the driver (when the vehicle performs autonomous driving related operations).

According to an embodiment, the prediction reduced the amount of driver interference with the autonomous driving of the vehicle—especially taking control over the vehicle (which is a resource consuming operation).

According to an embodiment, the prediction is used during off-line testing of the policy model—and assists in fine tuning or configuring the policy model.

According to an embodiment, the interpretable representation is human interpretable representation that is used for evaluating the policy module, or for debugging the policy module, of for fine tuning or configuring the policy model.

According to an embodiment, the predicted outcomes of the policy model during a period of time are based on analysis of different driving behaviors of different drivers. According to an embodiment, the analysis includes training the policy model.

According to an embodiment, the policy model is trained using training information. According to an embodiment, the training information includes sensed information regarding the environments and behaviors (of one or more vehicles driven by one or more drivers) following the reception of the sensed information.

According to an embodiment, the policy model outputs driving decisions that once applied results in a vehicle behavior that is impacted (may for example mimic and/or resemble) one or more acceptable driving behaviors.

Accordingly—the training may be preceded by selecting training information related to behaviors that are regarded to be acceptable.

What amounts to an acceptable behavior may be determined in one or more manner—such as:
a. Determined based on the outcome of the behavior, for example—a desired behavior does not result in damaging the vehicle or being involved in a near accident (almost an accident), yet for another example—the desired behavior did not stress the driver or any passenger (or having a stress below a stress threshold).
b. Determined based on feedback or labeling or any metadata (provided by a third party or an analyzer that reviews the behavior) related to the information, and the like.

According to an embodiment, the training the policy model involves using training information related to different acceptable behaviors caused the policy model to be responsive to the different acceptable behaviors. According to an embodiment, the outcome of the policy model represents one or more acceptable behaviors.

According to an embodiment, the interpretable representation is responsive to the different acceptable behaviors—and may represent one or more acceptable behaviors.

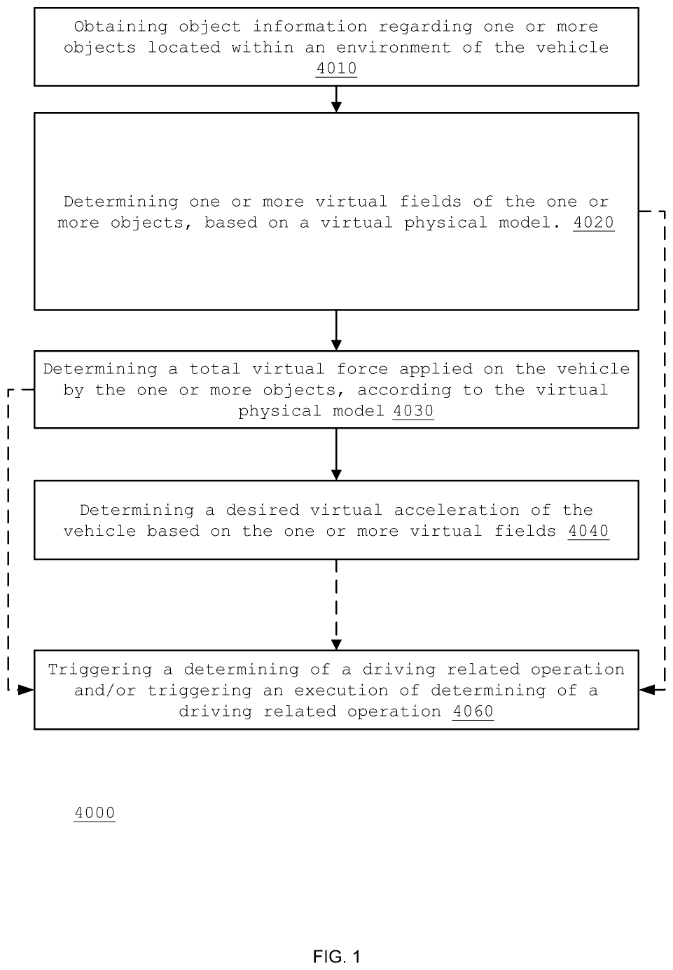

FIG. 1 illustrates an example of method 5000 that is computer implemented and is for explainable representation.

According to an embodiment, method 5000 includes step 5010 of receiving, by an auxiliary representation network, information regarding an environment of a vehicle. The information being destined to be processed by a policy model, to provide driving related decisions at a current point of time.

According to an embodiment, step 5010 is repeated during a driving session of a vehicle.

According to an embodiment, step 5010 is followed by step 5020 of generating, by the auxiliary representation network, an interpretable representation of predicted outcomes of the policy model during a period of time (POD) that ends after the current point of time.

According to an embodiment, the length of the POD may range from 1 second to 5, 10, 15, 20 seconds—and even more.

According to an embodiment, step 5020 is followed by step 5030 responding to the generating, by the auxiliary representation network, of the interpretable representation.

According to an embodiment, the interpretable representation is a graphical representation. According to an embodiment, the graphical representation includes at least one out of text, mathematical symbols, numbers, symbols, shapes, or any other graphical elements. Step 5030 includes displaying the graphical representation.

According to an embodiment, the vehicle includes a display for displaying the interpretable representation and step 503 includes displaying the interpretable representation. The display may be a part of a multimedia system, may be a holographic display, may be a part of a window of the vehicle, and the like.

According to an embodiment, the interpretable representation is an audio representation. According to an embodiment, the vehicle includes a loudspeaker for playing the interpretable representation step 5030 includes sounding the interpretable representation.

According to an embodiment, the interpretable representation is an audio-visual interpretable representation and includes both visual content and an audio content. Step 5030 includes making the audio-visual interpretable representation accessible to a driver and/or a passenger of the vehicle.

According to an embodiment, the interpretable representation is provided to one or more computerized systems and/or units—such as but not limited to a mobile phone of a user (driver and/or passenger and/or a user positioned outside the vehicle and/or a debugger or a computer expert, and the like), or a mobile multimedia unit of a user, or a computerized system located outside the vehicle, and the like. Step 5030 includes transmitting or otherwise making the interpretable representation accessible to the one or more computerized systems and/or units.

According to an embodiment, the interpretable representation is a computer interpretable representation, and step 5030 includes triggering a processing of the interpretable representation by a computerized system to provide a human interpretable representation.

According to an embodiment, step 5030 includes transmitting the interpretable representation to the computerized device. According to an embodiment, the computerized device is a part of the vehicle. According to an embodiment, the computerized device is not a part of a vehicle.

According to an embodiment, the interpretable representation is a media file that once provided to a media player is played by the media player. Step 5030 includes providing the media file to the media player and/or playing the medial file.

According to an embodiment, step 5030 includes trigging a visualization of the predicted outcomes of the policy model.

According to an embodiment, the interpretable representation is a visual representation that is overlaid over an image of the environment of the environment.

According to an embodiment, the interpretable representation represents a virtual acceleration of the vehicle along a driving path that corresponds to the predicted outcomes of the policy model.

According to an embodiment, applying method 5000 is dramatically (for example by at least a factor of 2) more efficient (from a computational resource point of view) than the generation, by the policy model, of the actual outcomes of the policy module during the period of time.

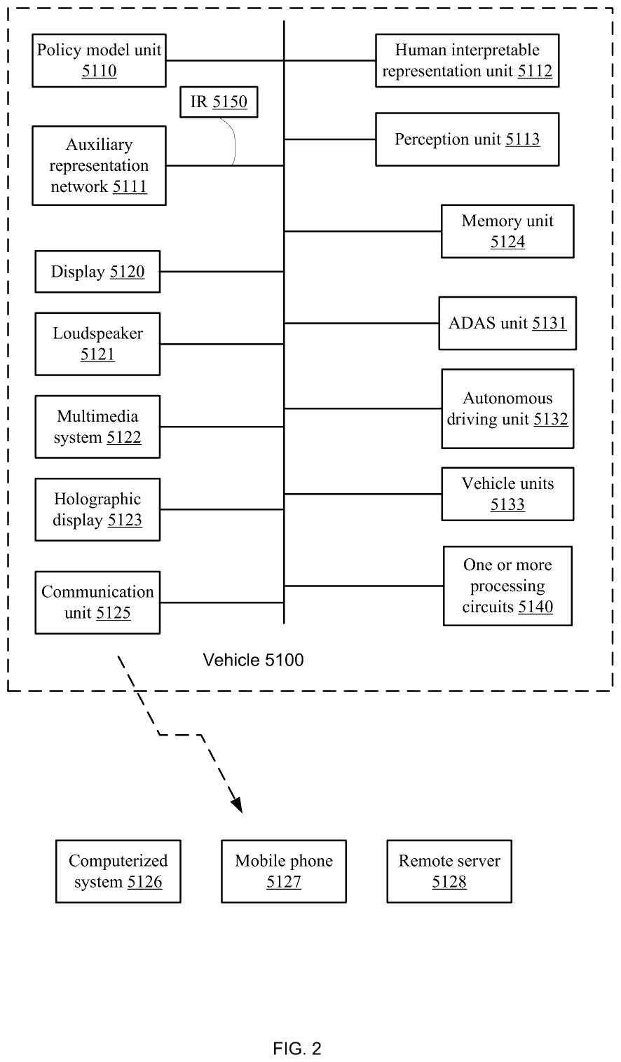

FIG. 2 is an example of a vehicle 5100 and some out-of-vehicle units.

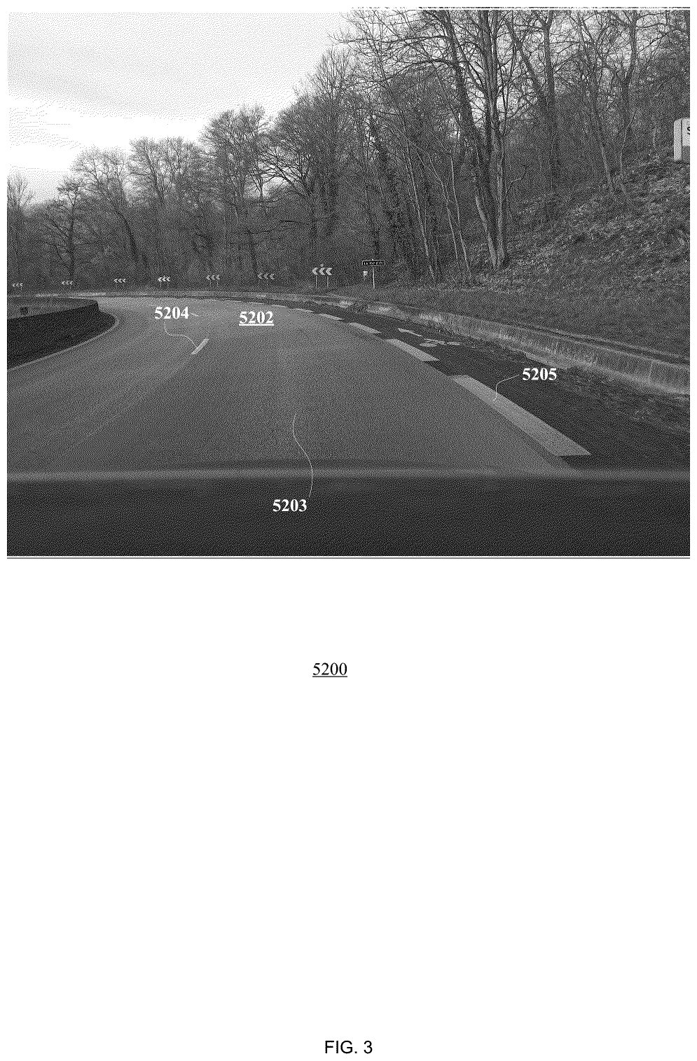

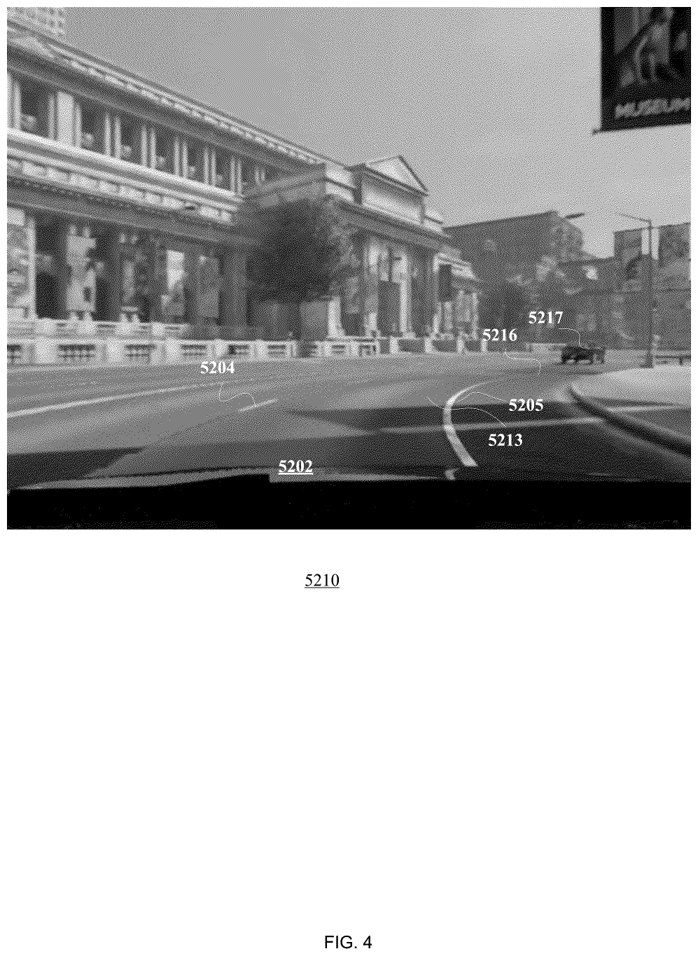

According to an embodiment vehicle 510 includes at least some of the following units and/or circuits:
a. Auxiliary representation network 5111 that is configured to execute at least a part of method 5000—for example execute at least steps 5010 and 5020. FIG. 2 illustrates that the auxiliary representation network 5112 outputs interpretable representation (denoted “IR”) 5150.
b. Policy model unit 5110 that is configured to apply the policy model. According to an embodiment, the outcome of the policy model impacts the driving of the vehicle.
c. One or more units for providing a human interpretable representation. The one or more units of FIG. 2 includes display 5120, loudspeaker 5121, multimedia system 5122, holographic display 5123.
d. Communication unit 5125 configured to communicate with out-of-vehicle devices and/or units and, additionally or alternatively, configured to communicate with other units of the vehicle.
e. Human interpretable representation unit 5112 configured to convert IR 5150 to a human interpretable representation. For example—when IR 5150 per se is not human interpretable. Human interpretable representation unit 5112 may be a man machine interface or may be configured to generate instructions to be converted to audio and/or visual information perceivable by a human. According to an embodiment, the human interpretable representation is a visual representation and the human interpretable representation unit 5112 determines the virtual representation to fit an image of an environment of the vehicle—for example determined the visual representation to be accurately overlaid over the image of the environment of the vehicle. Examples of overlaying visual representation on images are included in FIGS. 3 and 4.
f. Memory unit 5124 that is configured to store information such as sensed information and/or previously generated human interpretable representations, and/or current human interpretable representations.
g. ADAS unit 5131 configured to determine and/or control one or more ADAP operation related to the vehicle, following the generation of the outcome of the policy model unit.
h. Autonomous driving unit 5132 configured to determine and/or control one or more autonomous driving operation related to the vehicle, following the generation of the outcome of the policy model unit.
i. Vehicle units 5133 configured to operate based on instructions from ADAS unit 5131 and/or instructions from autonomous driving unit 5132 and/or outcomes of the policy model unit. Non limiting examples of the vehicle units include vehicle computers, engine, cooling system, brakes, and the like.
j. One or more processing circuits 5140 that are configured to implements at least a part of any one of the mentioned above units—such as auxiliary representation network 5111, policy model unit 5110, human interpretable representation unit 5112, ADAS unit 5131 and/or autonomous driving unit 5132.

According to an embodiment, the auxiliary representation network 5111 is included in any other unit—located within he vehicle or outside the vehicle.

According to an embodiment, the auxiliary representation network is executed by or hosted by a processing circuit of the vehicle—or outside the vehicle.

According to an embodiment, the auxiliary representation network is provided a service (for example a software as a service SaaS) from the vehicle or from outside the vehicle.

According to an embodiment, the interpretable representation is transmitted to recipients such as computerized system 1526, mobile phone 1527 and remote server 1528—illustrated as not being included in the vehicle.

According to an embodiment—any combination or sub-combination of any of the recipients of FIG. 2 may be provided. For example—a remote computerized system may differ from a remote server.

According to an embodiment, the human interpretable representation is a visual representation that represents the outcome of applying the policy model. According to an embodiment—the virtual representation represents virtual accelerations that are virtually applied on a vehicle when the vehicle is positioned at different locations within the environment of the vehicle.

According to an embodiment, the virtual acceleration represents the virtual impact of one or more objects within the environment on the vehicle. Examples for calculating the virtual acceleration are provided in each one of U.S. patent application Ser. No. 18/355,324 filing date Jul. 19, 2023 and in U.S. patent application Ser. No. 17/823,069 filing date Aug. 29, 2022—both are incorporated herein by reference.

According to an embodiment, the virtual acceleration increases with an increase of a deviation of a vehicle behavior from acceptable vehicle behavior.

FIG. 3 includes image 5200 that includes the predicted outcomes of the policy model during a period of time of a few seconds—and the virtual representation is overlaid on the lane.

The virtual representation is indicative of the predicted outcomes of the policy model during a period of time of a few seconds.

According to the predicted outcomes of the policy model during a period of time of a few seconds—the vehicle should stay aligned with a lane 5202—and is induced to have its center propagate along the middle of the lane—or at least within a center region 5203 of the lane. The visual representation is overlaid on the lane, is virtually transparent at the center region 5203 and has increasing intensity when getting closer to the lane boundaries 5204 and 5205.

According to an embodiment, the center region is impacted by having training information (of the policy model) that includes different acceptable driving patterns).

FIG. 4 includes image 5210 that includes the predicted outcomes of the policy model during a period of time of a few seconds—and the virtual representation is overlaid on the lane.

The virtual representation is indicative of the predicted outcomes of the policy model during a period of time of a few seconds.

According to the predicted outcomes of the policy model during a period of time of a few seconds—the vehicle should stay aligned with a lane 5202—and is induced to have its center propagate along the middle of the lane—or at least within a center region 5203 of the lane—until closing a gap to vehicle 5217—in which the vehicle has to slow down—as illustrated by non-transparent region 5216. Before reaching the non-transparent region 5216, and during at least an intermediate part of the path—the virtual representation is virtually transparent at the center region 5203 and has increasing intensity when getting closer to the lane boundaries 5204 and 5205.

Examples related to virtual acceleration and virtual fields are illustrated in method 400.

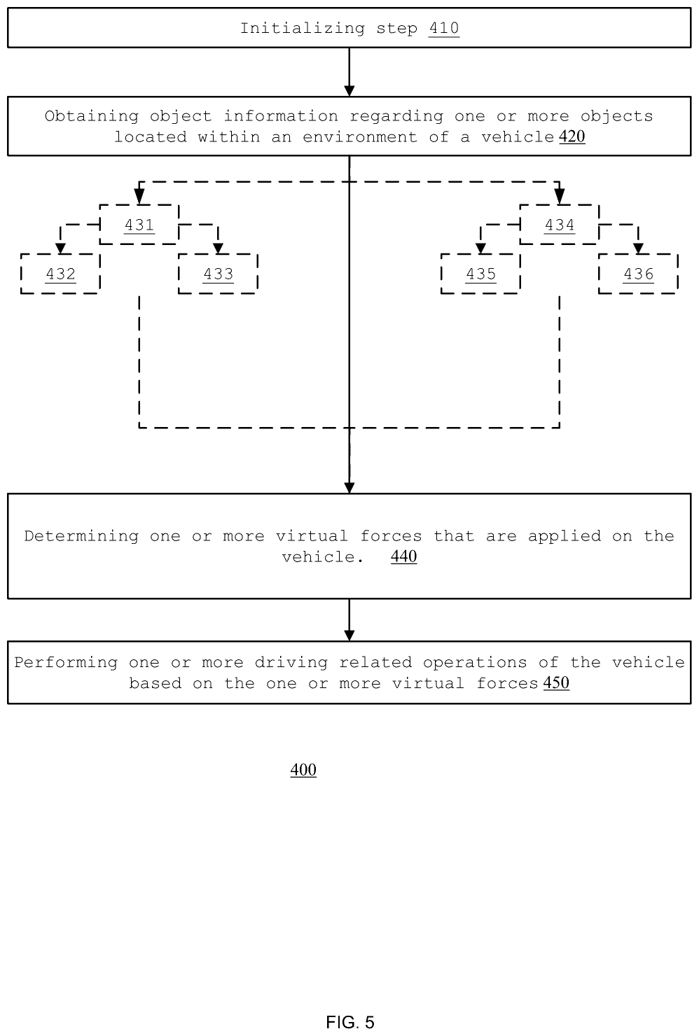

FIG. 5 illustrates an example of method 400 for driving related virtual fields.

Method 400 may be for perception fields driving related operations.

Method 400 may start by initializing step 410.

Initializing step 410 may include receiving a group of neural networks (NNs) that are trained to execute step 440 of method 400.

Alternatively, step 410 may include training a group of NNs that to execute step 440 of method 400.

Various examples of training the group of NNs are provided below.
a. According to an embodiment, the group of NNs are trained to map the object information to the one or more virtual forces using behavioral cloning.
b. According to an embodiment, the group of NNs are trained to map the object information to the one or more virtual forces using reinforcement learning.
c. According to an embodiment, the group of NNs are trained to map the object information to the one or more virtual forces using a combination of reinforcement learning and behavioral cloning.
d. According to an embodiment, the group of NNs are trained to map the object information to the one or more virtual forces using a reinforcement learning that has a reward function that is defined using behavioral cloning.
e. According to an embodiment, the group of NNs are trained to map the object information to the one or more virtual forces using a reinforcement learning that has an initial policy that is defined using behavioral cloning.
f. According to an embodiment, the group of NNs are trained to map the object information to the one or more virtual forces and one or more virtual physical model functions that differ from the perception fields.
g. According to an embodiment, the group of NN includes a first NN and a second NN, wherein the first NN is trained to map the object information to the one or more perception fields and the second NN was trained to map the object information to the one or more virtual physical model functions.

According to an embodiment, initializing step 410 is followed by step 420 of obtaining object information regarding one or more objects located within an environment of a vehicle. Step 410 may be repeated multiple times—and the following steps may also be repeated multiple times. The object information may include video, images, audio, or any other sensed information.

Step 420 may be followed by step 440 of determining, using one or more neural network (NNs), one or more virtual forces that are applied on the vehicle.

The one or more NNs may be the entire group of NNs (from initialization step 410) or may be only a part of the group of NNs—leaving one or more non-selected NNs of the group.

The one or more virtual forces represent one or more impacts of the one or more objects on a behavior of the vehicle. The impact may be a future impact or a current impact. The impact may cause the vehicle to change its progress.

The one or more virtual forces belong to a virtual physical model. The virtual physical model is a virtual model that may virtually apply rules of physics (for example mechanical rules, electromagnetic rules, optical rules) on the vehicle and/or the objects.

Step 440 may include at least one of the following steps:
a. Calculating, based on the one or more virtual forces applied on the vehicle, a total virtual force that is applied on the vehicle.
b. Determining a desired virtual acceleration of the vehicle based on an total virtual acceleration that is applied on the vehicle by the total virtual force. The desired virtual acceleration may equal the total virtual acceleration—or may differ from it.

Method 400 may also include at least one of steps 431, 432, 433, 434, 435 and 436.

Step 431 may include determining a situation of the vehicle, based on the object information.

Step 431 may be followed by step 432 of selecting the one or more NNs based on the situation.

Additionally or alternatively, step 431 may be followed by step 433 of feeding the one or more NNs with situation metadata.

Step 434 may include detecting a class of each one of the one or more objects, based on the object information.

Step 434 may be followed by step 435 of selecting the one or more NNs based on a class of at least one object of the one or more objects.

Additionally or alternatively, step 434 may be followed by step 436 of feeding the one or more NNs with class metadata indicative of a class of at least one object of the one or more objects.

Step 440 may be followed by step 450 of performing one or more driving related operations of the vehicle based on the one or more virtual forces.

Step 450 may be executed without human driver intervention and may include changing the speed and/or acceleration and/or the direction of progress of the vehicle. This may include performing autonomous driving or performing advanced driver assistance system (ADAS) driving operations that may include momentarily taking control over the vehicle and/or over one or more driving related units of the vehicle. This may include setting, without or without human driver involvement, an acceleration of the vehicle to the desired virtual acceleration.

Step 440 may include suggesting to a driver to set an acceleration of the vehicle to the desired virtual acceleration.

In the foregoing detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of the units and/or modules that are illustrated in the application, may be implemented in hardware and/or code, instructions and/or commands stored in a non-transitory computer readable medium, may be included in a vehicle, outside a vehicle, in a mobile device, in a server, and the like.

The vehicle may be any type of vehicle—for example a ground transportation vehicle, an airborne vehicle, or a water vessel.

The specification and/or drawings may refer to an image. An image is an example of a media unit. Any reference to an image may be applied mutatis mutandis to a media unit. A media unit may be an example of sensed information unit (SIU). Any reference to a media unit may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to a sensed information unit (SIU). The SIU may be of any kind and may be sensed by any type of sensors—such as a visual light camera, an audio sensor, a sensor that may sense infrared, radar imagery, ultrasound, electro-optics, radiography, LIDAR (light detection and ranging), a thermal sensor, a passive sensor, an active sensor, etc. The sensing may include generating samples (for example, pixel, audio signals) that represent the signal that was transmitted, or otherwise reach the sensor. The SIU may be one or more images, one or more video clips, textual information regarding the one or more images, text describing kinematic information about an object, and the like.

Object information may include any type of information related to an object such as but not limited to a location of the object, a behavior of the object, a velocity of the object, an acceleration of the object, a direction of a propagation of the object, a type of the object, one or more dimensions of the object, and the like. The object information may be a raw SIU, a processed SIU, text information, information derived from the SIU, and the like.

An obtaining of object information may include receiving the object information, generating the object information, participating in a processing of the object information, processing only a part of the object information and/or receiving only another part of the object information.

The obtaining of the object information may include object detection or may be executed without performing object detection.

A processing of the object information may include at least one out of object detection, noise reduction, improvement of signal to noise ratio, defining bounding boxes, and the like.

The object information may be received from one or more sources such as one or more sensors, one or more communication units, one or more memory units, one or more image processors, and the like.

The object information may be provided in one or more manners—for example in an absolute manner (for example—providing the coordinates of a location of an object), or in a relative manner—for example in relation to a vehicle (for example the object is located at a certain distance and at a certain angle in relation to the vehicle.

The vehicle is also referred to as an ego-vehicle.

The specification and/or drawings may refer to a processor or to a processing circuit.

According to an embodiment, a processor is or includes one or more processing circuits. According to an embodiment, A processing circuit is implemented as a central processing unit (CPU) and/or as one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly—any reference to object detection is applicable mutatis mutandis to a pattern detection.

In the foregoing specification, the invention has been described with reference to specific examples of embodiments of the invention. It will, however, be evident that various modifications and changes may be made therein without departing from the broader spirit and scope of the invention as set forth in the appended claims. Moreover, the terms “front,” “back,” “top,” “bottom,” “over,” “under” and the like in the description and in the claims, if any, are used for descriptive purposes and not necessarily for describing permanent relative positions.

Any reference to “comprising” should be applied, mutatis mutandis, to “consisting”.

Any reference to “comprising” should be applied, mutatis mutandis, to “consisting essentially of”.

It is understood that the terms so used are interchangeable under appropriate circumstances such that the embodiments of the invention described herein are, for example, capable of operation in other orientations than those illustrated or otherwise described herein. Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality. Any arrangement of components to achieve the same functionality is effectively “associated” such that the desired functionality is achieved.

Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality. Furthermore, those skilled in the art will recognize that boundaries between the above described operations are merely illustrative. The multiple operations may be combined into a single operation, a single operation may be distributed in additional operations and operations may be executed at least partially overlapping in time.

Moreover, alternative embodiments may include multiple instances of a particular operation, and the order of operations may be altered in various other embodiments. Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense. In the claims, any reference signs placed between parentheses shall not be construed as limiting the claim. The word ‘comprising’ does not exclude the presence of other elements or steps then those listed in a claim.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

The mere fact that certain measures are recited in mutually different claims does not indicate that a combination of these measures cannot be used to advantage. While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination. It will be appreciated by people skilled in the art that the embodiments of the disclosure are not limited by what has been particularly shown and described hereinabove. Rather the scope of the embodiments of the disclosure is defined by the appended claims and equivalents thereof.

What is claimed is:

1. A method that is computer implemented and is for explainable representation, the method comprises:
receiving, by an auxiliary representation network, information regarding an environment of a vehicle; the information being destined to be processed by a policy model, to provide driving related decisions at a current point of time;
generating, by the auxiliary representation network, an interpretable representation of predicted outcomes of the policy model during a period of time that ends after the current point of time.

2. The method according to claim 1, wherein the interpretable representation is a human interpretable representation.

3. The method according to claim 1, wherein the interpretable representation is a visual representation that is overlaid over an image of the environment of the environment.

4. The method according to claim 1, wherein the auxiliary representation network is trained based on a dataset comprising (a) information regarding environments of vehicles, and (b) outputs generated by policy models of the vehicles.

5. The method according to claim 1, wherein the interpretable representation represents a virtual acceleration of the vehicle along a driving path that corresponds to the predicted outcomes of the policy model.

6. The method according to claim 1, wherein the generation of the interpretable representation being fed to a visualization of the predicted outcomes of the policy model.

7. The method according to claim 1, wherein the interpretable representation is a computer interpretable representation, wherein the method comprises triggering a processing of the interpretable representation by a computerized system to provide a human interpretable representation.

8. The method according to claim 1, wherein the interpretable representation is a visual representation.

9. The method according to claim 1 wherein (i) the generating of the interpretable representation of the predicted outcomes of the policy model during the period of time consumes a first amount of computational resources, and (ii) a generating of actual outcomes of the policy module during the period of time consumed a second amount of computational resources that is at least twice the first amount of computational resources.

10. The method according to claim 1, wherein the predicted outcomes of the policy model during the period of time are based on analysis of different driving behaviors of different drivers.

11. A non-transitory computer readable medium for explainable representation, the non-transitory computer readable medium stores instructions for:
receiving, by an auxiliary representation network, information regarding an environment of a vehicle; the information being destined to be processed by a policy model, to provide driving related decisions at a current point of time; and
generating, by the auxiliary representation network, an interpretable representation of predicted outcomes of the policy model during a period of time that ends after the current point of time.

12. The non-transitory computer readable medium according to claim 11, wherein the interpretable representation is a human interpretable representation.

13. The non-transitory computer readable medium according to claim 11, wherein the interpretable representation is a visual representation that is overlaid over an image of the environment of the environment.

14. The non-transitory computer readable medium according to claim 11, wherein the auxiliary representation network is trained based on a dataset comprising (a) information regarding environments of vehicles, and (b) outputs generated by policy models of the vehicles.

15. The non-transitory computer readable medium according to claim 11, wherein the interpretable representation represents a virtual acceleration of the vehicle along a driving path that corresponds to the predicted outcomes of the policy model.

16. The non-transitory computer readable medium according to claim 11, wherein the generation of the interpretable representation being fed to a visualization of the predicted outcomes of the policy model.

17. The non-transitory computer readable medium according to claim 11, wherein the interpretable representation is a computer interpretable representation, wherein the method comprises triggering a processing of the interpretable representation by a computerized system to provide a human interpretable representation.

18. The non-transitory computer readable medium according to claim 11, wherein the interpretable representation is a visual representation.

19. The non-transitory computer readable medium according to claim 11 wherein (i) the generating of the interpretable representation of the predicted outcomes of the policy model during the period of time consumes a first amount of computational resources, and (ii) a generating of actual outcomes of the policy module during the period of time consumed a second amount of computational resources that is at least twice the first amount of computational resources.

20. The non-transitory computer readable medium according to claim 11, wherein the predicted outcomes of the policy model during the period of time are based on analysis of different driving behaviors of different drivers.
